(19) United States
(12) Patent Application Publication
(10) Pub. No.: US 2012/0052821 A1
(43) Pub. Date: Mar. 1, 2012

(54) Perturbation antenna system and apparatus for wireless terminals

(76) Inventors: Dongxun Jia, Ottawa (CA); Shiquan Wu, Ottawa (CA)

(21) Appl. No.: 13/137,465

(22) Filed: Aug. 18, 2011

Related U.S. Application Data
(60) Provisional application No. 61/344,579, filed on Aug. 25, 2010.

(51) Int. Cl. H04B 1/38

(52) U.S. Cl. 455/90.2

(57) ABSTRACT

This is invention discloses a perturbation antenna system for wireless communication terminals such mobile handsets, mobile embedded laptops, mobile CPEs (Customer premises equipment), nomadic wireless CPEs, fixed wireless terminals and etc. The perturbation antenna output is analogically combined with that of the primary antenna. The combined result is to re-create the antenna pattern shape and its direction pointing in order to achieve gains by user intercept. A variable delay circuitry is equipped to the perturbation antenna therefore the user's interception can be enforced via programmable apparatus either by manually or by digital inputs. The user can tune the delay parameters meanwhile observe the antenna pattern changes and the call quality until satisfaction.

### CLAIM OF PRIORITY

This patent application claims the benefit of priority from U.S. Provisional Patent Application No. 61/344,579 filed on Aug. 25, 2010. This application incorporates by reference the entire disclosure of U.S. Provisional Patent Application No. 61/344,579.

### FIELD OF THE INVENTION

The embodiments of the invention relate generally to wireless user terminal antenna system, apparatus and reception improvement technologies.

### BACKGROUND OF THE INVENTION

In general, a wireless communication system has four major subsystems, i.e. antenna system, radio system, base band processing system and MAC processor. Antenna is responsible to pick up a signal or to radiate a signal; radio system will select and regulate the interested signal coming down from an antenna or regulate the signal from base band subsystem before it goes to the air; base band processing is the place where messages get processed such as encoding/decoding, modulation and demodulation, encryption/decryption, filtering etc.; MAC (media access control) subsystem will re-format the messages properly either suitable for transmission or suitable for reception.

Antenna system is the first place to intercept the electromagnetic waves. Antenna performance is therefore critical for a radio link quality. In theory, the optimal antenna size is proportional to wavelength. The early wireless communication terminal had larger form factor with a remarkably sized external antenna. Antenna design was relatively easy to guarantee a designated performance, for example, 0 dB gain or better.

Today's wireless terminals, particularly smart mobile phones are tiny, cute and aesthetic good looking gadgets with many highly integrated electronic modules. So large size external antennas have been replaced by internal small size antennas. This trend makes terminal antenna design a big challenge and a differentiator in balancing between antenna gains versus antenna form factor. Antenna gain is a parameter that determines radio link coverage while antenna form factor restricts the terminal size and PCB (printed Circuit board) layout. In particular, when antenna size is too small comparing to carrier frequency wavelength, the antenna will produce loss rather than gain.

In the mean time, the emerging wireless systems all equipped with higher modulation and coding schemes in order to enable broadband services. This new requirement put a lower limit on antenna loss.

Following Shannon's capacity theorem, within a fixed bandwidth, ongoing pursue of higher data throughput and higher spectrum efficiency must be fulfilled by increasing signal-to-noise ratio (SNR).

There are many techniques implemented in practice to increase the SNR. One common practice is diversity reception. The wireless modem uses two or more independent receiving circuits and combines base band signals before demodulation and decoding. One popular algorithm is MRC (Maximum Ratio Combining) which multiplies a proper weight factor to each stream of baseband output and then adds them together for further processing. MRC usually provides 3+ dB gains for two antennas against one antenna system.

Beam forming system, as another popular antenna technique, uses an array of antennas, which are normally equally spaced. By multiplying a pre-designed weight to each antenna output, the antenna array beam pattern can be steered and narrowed therefore the received signal quality can be improved.

However, all those techniques are mainly applied to base station side. It is hardly seen in user terminal side due to additions of hardware costs; more processing power required and increased software complexity.

One embodiment of this invention is to disclose a perturbation antenna system and associated apparatus that can recreate antenna pattern in the terminal with user's perception.

Another embodiment of the invention is to create side lobs so that it percepts the signal from other directions of signals arrivals as well.

The foregoing embodiments of the invention are illustrative that can be implemented by the various exemplary embodiments and their detailed illustrations. Thus, these and other embodiments and advantages of the various exemplary embodiments will be apparent from the illustrations and examples herein or can be learned from the various exemplary embodiments, both as embodied herein or as modified variations that are apparent to those persons skilled in the art.

### SUMMARY OF THE INVENTION

In a real wireless environment, a large portion of signals arrive at the user terminal are in multi-path form. The angles of signal arrivals completely depend on the surrounding environments and are random in nature. In order to collect multi-path signals, conventional terminal antennas are designed isotropic. That means, most of the antenna, if not all, has 0 dB gain or even has loss. In order to meet the SNR requirements of the 3G/4G systems, current terminal antennas have to be improved or re-designed to gain 2 to 3 dB SNR or even more.

The object of this invention is to provide a practical way to improve the existing antenna performance by adding another perturbation antenna and associated apparatus. The perturbation antenna will analogically combine with one existing primary antenna. With user's input and perception, the perturbation antenna phases can be changed to produce desired perturbation so that the overall antenna system pattern can be reshaped and redirected.

Unlike common beam formers or MRC type of diversity technologies, the invented method is simple in implementation without complicate signal processing required. The phase modification of the perturbation antenna can be achieved manually or automatically via a variable delay line circuitry which will be further detailed in the forthcoming specification.

After combining perturbation antenna output, the overall antenna system will have higher reception gain; the overall main beam width changes to collect desired signals and/or reject unwanted interference; the reception beam can be steered to collect desired signals from preferred directions; the side lobes of the antennas get intensified or diminished which can collect desired multi-path signals and/or reject unwanted interference. The simulated scenarios have been plotted in FIG. 2, 3, 4 and FIG. 6, 7, 8.

The invented method enables terminal users to enhance their signal reception through their inputs and perception. Users can simply dial an electro-mechanical device to tune the phases for perturbation antenna and to optimize the overall antenna pattern for the best reception.

### DESCRIPTION OF DRAWINGS

FIG. 1 shows a system architecture on how to improve one antenna system with a perturbation antenna

FIG. 2 plots the overall antenna pattern when one primary antenna combined with a perturbation antenna with a separation space 0.2λ. In this simulation, t1 is set to zero, i.e. the primary antenna has no delay effect; t2 is the variable delay for the perturbation antenna

FIG. 3 plots another scenario that the separation distance between primary antenna and the perturbation antenna is set to 0.5λ.

FIG. 4 plots yet another scenario that the separation distance between primary antenna and the perturbation antenna is set to 1λ.

FIG. 5 shows another system architecture on how to improve 2 primary antennas system with MRC via a perturbation antenna

FIG. 6 plots the beam patterns for 2 primary antennas with 1 perturbation antenna and all line positioned with an equal separation space 0.2λ. The primary antennas have no delay effect and perturbation antenna varies its delay parameters.

FIG. 7 and FIG. 8 are similar plots of FIG. 6 except the separation distance are respectively set to 0.5λ and 1λ.

### DETAILED DESCRIPTION OF THE INVENTION

In a real wireless environment, a large portion of signals arriving at the user terminal is in multi-path form. The angles of signal arrivals completely depend on the surrounding environments and are random in nature. In order to collect multi-path signals, conventional terminal antennas are designed isotropic. Therefore, most of the terminal antennas, if not all, has 0 dB gain or even has loss. In order to meet the SNR requirements of the 3G/4G systems, current terminal antennas have to be improved or re-designed to gain more 2 to 3 dB SNR or even more. The object of this invention is to propose a perturbation antenna system and associated apparatus that will improve the existing user terminal antenna performance with easy implementation.

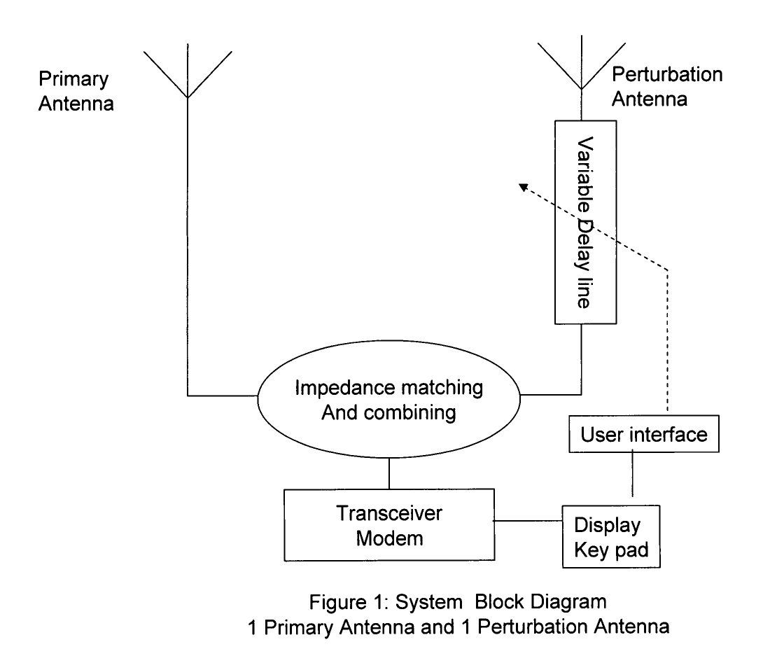

Refer to FIG. 1; there is an illustrated primary antenna along with a perturbation antenna. The primary antenna is same as the conventional ones. The perturbation antenna has a delay circuitry to alter the signal phases before the analog combining circuitry.

The perturbation antenna and the primary antenna have a fixed spacing and the perturbation antenna has an adjustable delay circuitry. After an impedance matching circuit, the signals from two primary antenna and perturbation antenna are analogically combined. The output of the combiner is fed into the receiver processor.

The delay circuitry can be controlled by dialing a manual dial or via a user interface on the display screen so that the delay parameter can be varied with the user's desire. As a result, the primary antenna beam pattern is perturbed both in shape and in direction of pointing. Usually 2 to 3 dB more gain can be achieved.

Another interesting observation is that some useful side lobes can be created to receive signals from other multi paths for some special antenna spacing.

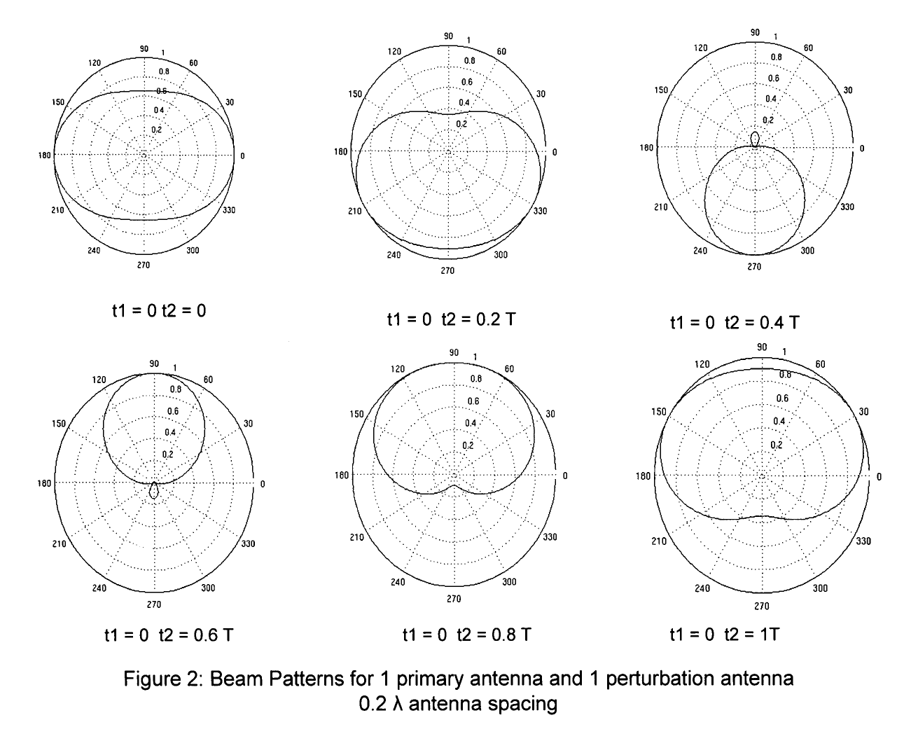

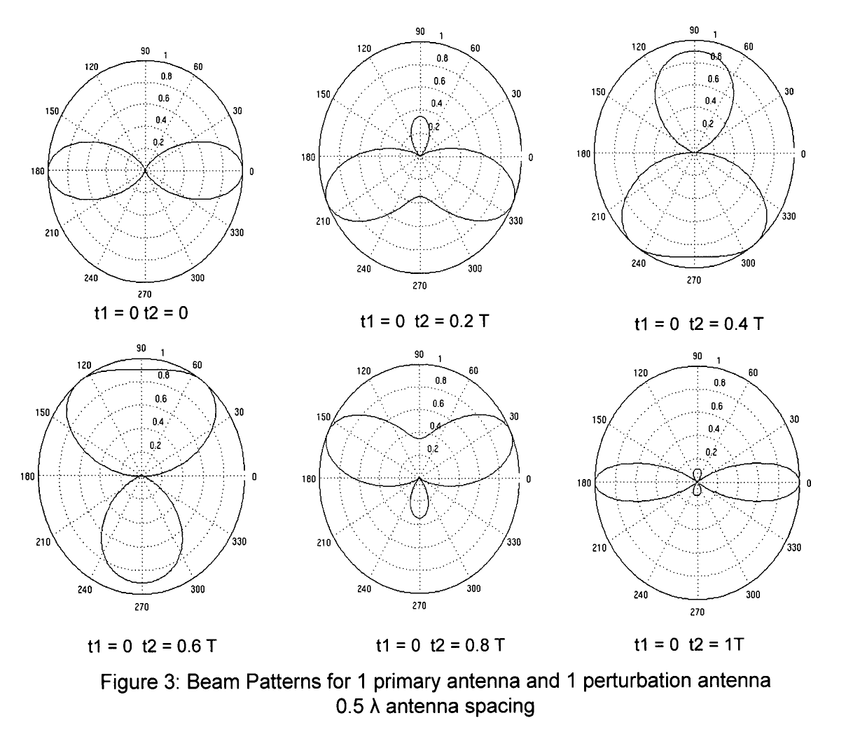

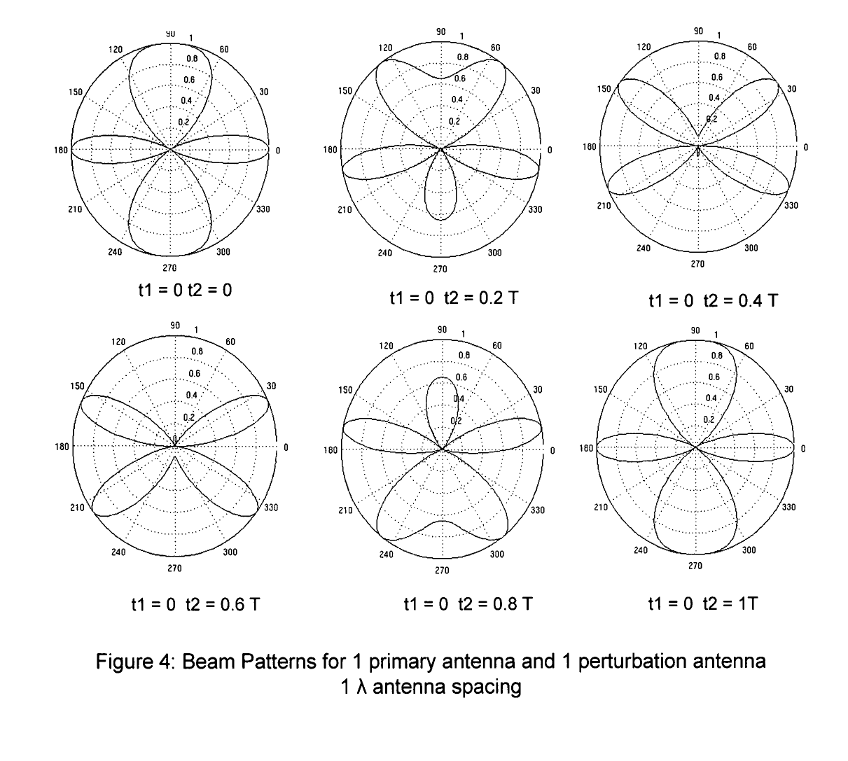

The beam patterns with various delays are summarized in FIG. 2, 3, 4.

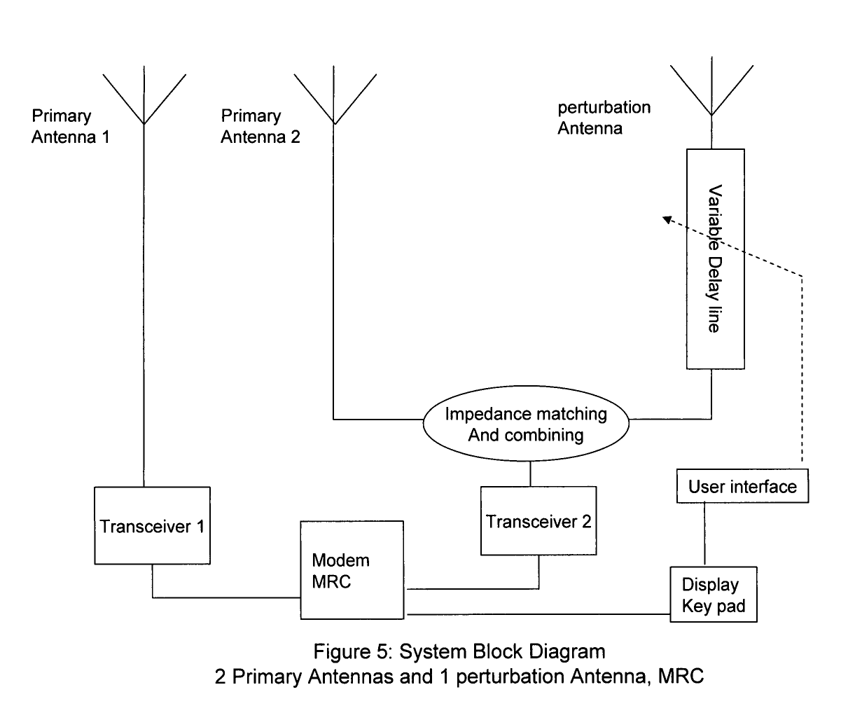

In another embodiment (referring to FIG. 5), there are two primary antennas which are used to do maximum ratio combining (MRC). Another perturbation antenna is added and is co-located with one of the 2 primary antennas so that 3 antennas are equally spaced with each other. Perturbation antenna has an adjustable delay circuitry which will be tuned by user to get a better reception performance.

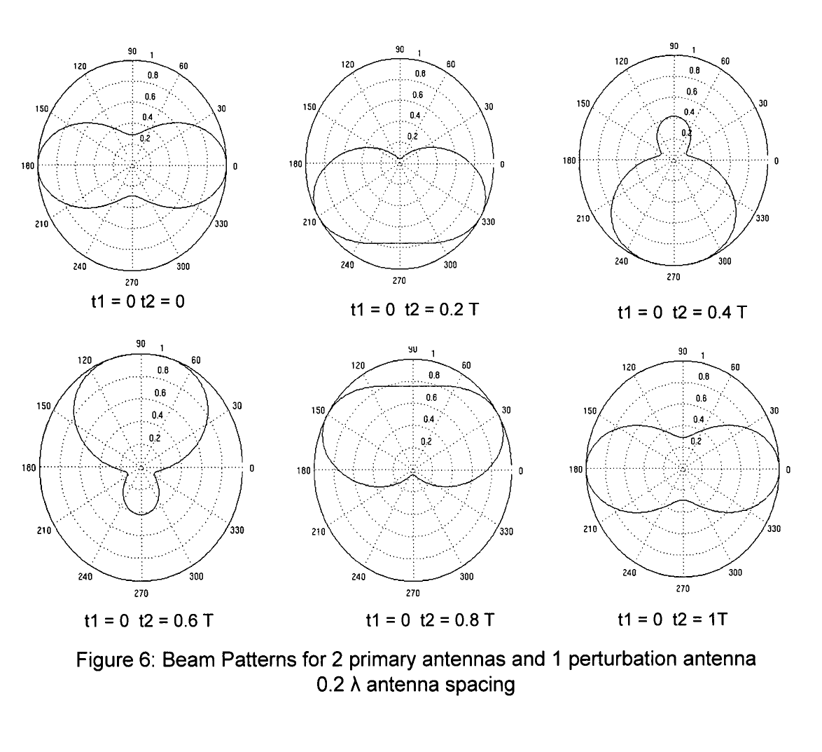

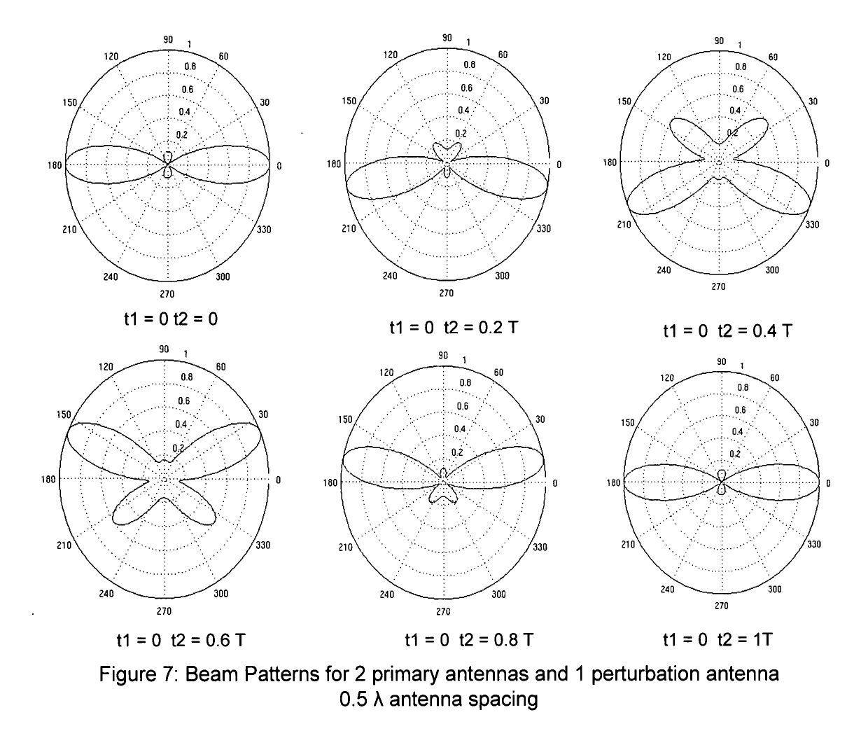

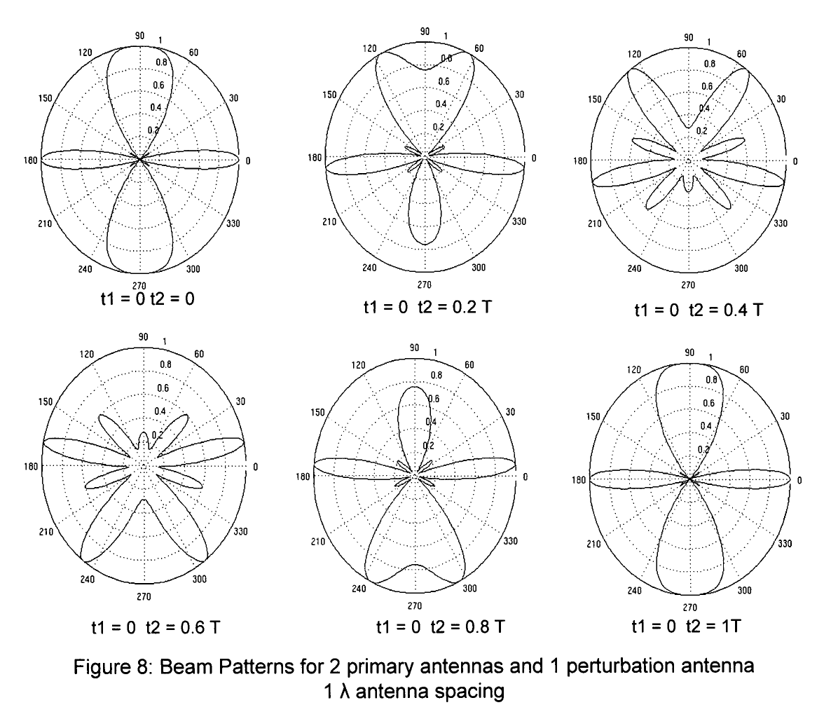

After an impedance matching circuit, the signals from the perturbation antenna analogically combines with one primary antennas output. The combiner output together with another primary antenna output will be used for MRC. By dialing a manual dial or via a user interface, user can vary the delay parameters. As a result, the beam pattern of two primary antennas is perturbed and redirected. The beam patterns with various delays are plotted in FIG. 6, 7, 8.

Further gain is evidenced in MRC module due to one of the primary antennas output is enhanced.

From the plotted beam patterns described in FIG. 2, 3, 4, 6, 7, 8, it can be seen that perturbation antenna with adjustable delay circuitry can effectively change the antenna/antennas reception beam pattern, pointing direction and side lobs. This will enable the user to tune his/her terminal receiver for a better performance.

We claim:

1. An user terminal with a perturbation antenna comprising:
a. A primary antenna and transceiver module
b. A perturbation antenna with an adjustable delay circuitry
c. An impedance matching circuitry with combining circuitry
d. An user interface that user can adjust the delay parameter
e. A display that can visualize the antenna pattern

2. A user terminal as claimed in claim 1, wherein the perturbation antenna has an adjustable delay circuitry.

3. An user terminal as claimed in claim 1, wherein the perturbation antenna can be placed beside the primary antenna with a distance of 0.2 wavelength or 0.4 wavelength or 0.618 wavelength or 0.8 wavelength or 1 wavelength.

4. A user terminal as claimed in claim 1, wherein the matching circuitry will have output impedance matched to the receiver impedance.

5. An user terminal as claimed in claim 1, wherein the user interface for adjusting the delay parameter can be a dial, a wheel, a key pad, a touch screen or a speaker phone.

6. A user terminal as claimed in claim 1, wherein the display will show the antenna pattern and gain when adjusting the delay parameters.

7. The perturbation antenna as claimed in claim 2, wherein the perturbation antenna can be the same copy as the primary antenna.

8. The perturbation antenna as claimed in claim 2, wherein the perturbation antenna can be different shape and orientation from the primary antenna.

9. The perturbation antenna as claimed in claim 2, wherein the perturbation antenna can be a separate external antenna which will be plug into user terminal when needed.

10. The combining circuitry as claimed in claim 1, wherein the combining is analog combining.
